(19) United States
(12) Patent Application Publication
(10) Pub. No.: US 2006/0277411 A1
(43) Pub. Date: Dec. 7, 2006

(54) Security and storage system and method

(76) Inventors: Christopher H. Reynolds, Wayland, MA (US); Stephen D. Fantone, Cambridge, MA (US); David A. Vogel, Norwood, MA (US)

Correspondence Address: WILMER CUTLER PICKERING HALE AND DORR LLP, 60 STATE STREET, BOSTON, MA, 02109, US

(21) Appl. No.: 11/296,675

(22) Filed: Dec. 7, 2005

Related U.S. Application Data
(60) Provisional application No. 60/634,032, filed on Dec. 7, 2004.

(51) Int. Cl. H04L 9/00

(52) U.S. Cl. 713/182

(57) ABSTRACT

A system and method are disclosed for securely handling data and information that may be used by an electronic information system. This includes storing and accessing data on a medium that has the appearance of a standard CD or DVD, but is novel in comparison thereto as to its structure and content. The system and method may be embodied in media that have characteristics of a CD or DVD but can take any shape permitted for a CD or DVD. Further, the system and method may be used for interconnection of electronic devices without the need of cables or conventional wireless connections. And, the system and method may provide for secure storage of data or information downloaded from a source, such music from the Internet.

### RELATED APPLICATIONS

This application claims the benefit of priority under 35 U.S.C. § 119(e) from U.S. Provisional Application Ser. No. 60/634,032 filed Dec. 7, 2004, entitled “Hotplate,” which is incorporated herein by reference.

### FIELD OF THE INVENTION

The present invention relates to system and methods that are used for effecting security for accessing and storing information on information systems and transporting information within information systems.

### BACKGROUND OF THE INVENTION

The security of information systems is an important issue for corporations and society at large. HIPAA-GLB-SarbOx regulations, incidents with disgruntled employees, highly publicized incidents of viruses and hacking, electronic identity theft, credit card hacking, online fraud, and increasing legal liability have elevated information security to a mainstream consideration wherever computers are used. Recent polls and studies show that a significant and increasing proportion of consumers are electing not to do business online due to security concerns. Despite these concerns, many organizations continue to rely on passwords for computer access and transaction validation.

Passwords impose two fundamental problems. The first is weak security, since passwords are relatively easy to compromise, and, therefore, fail to actually provide genuine security. The second is expense, since application vendors and IT departments typically try to mitigate the weakness of password-based systems by mandating password policies that carry very high technical support costs. These two issues will now be discussed in more detail.

Passwords dominate sign-on systems today. It has been found that passwords are routinely compromised, both in errors by users and deliberately by hackers. Passwords can regularly be found on Post-It™ notes near computer systems, on lists in misplaced or lost wallets, in lost emails, and on hard drives of discarded computers. They may also be easily obtained with very simple, effective software programs that logon and forward keyboard activity. Further, there are toolkits available on the World Wide Web dedicated to assisting hackers in compromising passwords.

In many cases, all one has to do to obtain a password is generate a web page that looks like a legitimate sign-on screen and ask the user for his or her password. This type of hacking is sometimes called spoofing. Another method called phishing is used to attempt to get people to enter their access codes and similar private information. Tutorials, including how-to examples, about spoofing and phishing are available on a number of websites. These websites even illustrate how to foil the alert mechanisms built into the most popular Internet browsers. Even worse, there are systems that employ robust measures, such as digital certificates and public-key cryptography, to guard communications, but still use passwords for initial access to the computer.

Likewise, numerous single sign-on systems, including Microsoft Passport™, employ a sole password to control access to multiple applications and sites. In these cases, the password becomes a master key. It can be very easy to mimic the entry site to purloin the password.

As stated, the second problem with password-based security is the high technical support costs. Computing environments have grown so complicated that most companies rely on corporate help desks to field the number of requests. To manage cost, some of these functions are being outsourced. Companies want to find a better, cheaper way to get their employees back to work as quickly as possible when this type of computer problem halts their productivity.

The main issue is “password reset.” The typical costs to companies per user per year for this problem are in the range of $75 to $200. Seventy percent (70%) of users have password problems at least once per month. Further, approximately thirty percent (30%) of help desk calls are for password resets. This results mainly from users losing or forgetting their passwords. In many cases, forgetting a password is understandable, because some corporate users may have to remember a large number of passwords for many applications. Each application may have different rules for acceptable passwords. The Internet has exacerbated the problem because of the number of useful sites that require a password. Many computer users in corporate settings are required to remember more thirty (30) passwords. There have even been situations in which purchasing agents have been required to remember seventy (70) passwords to access a broad array of supply-chain applications.

To improve security, many IT departments and security consultants recommend that passwords be changed frequently. Under this policy, the software requires frequent password changes and will reject sign-on attempts with expired passwords. Unless a user writes down his or her passwords, which actually compromises a security, it is easy to forget them.

The cost and inconvenience of password administration is just one example of the vast problem of authenticating users who need to access sensitive information in complex, distributed information systems. In addition to password management, related problems include, for example, validating users who intend to execute mutual fund access or credit card transactions online. There also are related problems with company and similar ID cards. Optimal application of these cards requires a challenging mix of features, including convenience, high security, and low total cost of use, including purchase, installation, training, and maintenance. To achieve this mix, applications would benefit from a system that is free from the requirement to purchase and install new card readers to complete card-based systems.

There are other related problems that are being faced today, such as the inconvenience and cost associated with moving information easily and securely between information appliances such as personal computers (PCs), personal digital assistants (PDAs), digital cameras, telephones, etc. The problems that have been noted are just representative of some of the security and convenience issues confronting the information systems industry. Below are further analyzed two representative problems, online credit card use and easy, secure device interconnectivity. These problems typify many similar problems general to today's information systems.

The usage of credit cards on the Internet is ever increasing and this upward growth is projected to continue. Many retailers have come to depend on online sales; in fact, many merchants have structured entire businesses around this model. However, fraud rates are 15 to 21 times higher for online transactions than they are for face-to-face transactions. Because of this, credit card companies have imposed draconian policies to manage the risk for online transactions.

Two policies have caused problems for online merchants. First, if an online merchant's chargeback rate exceeds certain levels, the credit card company, at its sole election, may elect to cut off all charging privileges for that merchant. The appeal process for online merchants to have their privileges reinstated can be uncertain and lengthy. So practically, the appeal process can result in the online merchant being put out of business.

Second, online merchants by their nature produce what the industry calls Card-Not-Present (CNP) transactions. In face-to-face transactions, the merchant can inspect the card and take reasonable steps to verify that the purchaser and cardholder are the same person. This type of verification dramatically reduces the rate of fraud.

If there is fraud in a face-to-face transaction, it is typically up to the credit card company, not the merchant, to absorb the cost of non-payment or pursue the matter itself. For major credit card companies, the face-to-face fraud rate is about $7 for every $10,000 in transactions charged. This low risk level is very acceptable for conducting these types of transactions. Consequently, credit card companies can confidently guarantee their merchants that they will be paid.

In an online transaction, the actual card is not presented to a merchant for verification. In such transactions, only the information on the card is presented. The result is that the fraud rates are significantly higher online, and credit card companies often require online merchants to cover chargebacks for CNP transactions. About eighty-five percent (85%) of chargebacks are due to cardholders repudiating the purchase. If the cardholder contends that he or she did not make a given purchase and will not pay the bill, the merchant has to absorb the cost of the transaction. Merchants can either forget about it, and consider chargebacks a cost of doing business, or they can try to pursue the matter directly with the purchaser. In the latter case, the merchant will typically receive little help from the credit card company. In fact, in some cases, the card company will refuse to even give the merchant the relevant contact information for the cardholder so that the merchant can pursue the matter itself.

The CNP chargeback problem is large. CNP transactions, including both Internet and telephone purchases, now account for approximately twenty-five percent (25%) of all credit card transactions. Minor steps toward improving verification of online purchasers are presently being made. Some of the major credit card issuers have introduced new data and software programs to help merchants better verify cards in Internet transactions. However, there is evidence that fraudulent card users have quickly learned how to obtain the additional pieces of cardholder information on which these verification programs rely. Moreover, the software programs provide a minor remedy with significant adverse side effects. Some of the programs employ pop-screens that cause Internet browser conflicts and irritate customers right at the climax of the purchasing process. Merchants have complained about the awkwardness of systems that interpose themselves in the payment process and cite this as one of the reasons for the industry's low prospect conversion rate: only 3.2% of website visitors go on to become buyers.

Hardware-based remedies also impose adverse side effects. Companies or their customers must provide and install the new hardware. This requirement presents unacceptable financial and operational costs. For example, it is not feasible for a credit-card company to provide and install a credit card reader at every personal computer the customer might want to use to make an online purchase.

In sum, the credit card industry is in a period of difficulty. The sole promising segment for growth is online transactions. However, this segment suffers from high fraud rates.

Device interconnectivity is also a burden for information systems users. Many users are averse to connecting plugs and cables and installing new hardware on their computers. These users are content with their current personal computers, and do not desire to perform the task of upgrading them because of suspected difficulties in doing so.

Some leading computer equipment manufacturers have turned to new information appliances for growth. These appliances include telephones, PDAs, digital cameras for video and still pictures, music players in a variety of formats, storage devices, and voice recorders. This strategy has expanded to existing lines of equipment as well, such as printers, monitors, and laboratory devices, which now include ports, memory options, and connectivity solutions that were pioneered for PDAs and music players.

Overall, this information appliance strategy has been somewhat successful for computer and electronics manufacturers. At present, unit sales of digital cameras have surpassed sales of conventional cameras. Music players have revolutionized the music distribution industry. Likewise, PDAs have become popular in both corporate and home settings. By adding cameras, larger screens, and network integration to information appliances, manufacturers have been able to keep the category on a growth curve.

While these devices can provide considerable conveniences, such as portability, they impose two major problems. These are complex connectivity and low security. Information appliances generally rely on cables and memory cards to communicate with other devices. The cables are lugubrious and expensive. The requirement for a special cable flouts portability, as the user must carry the cable around with the device or run the risk of not having one available when needed.

Like cables, memory cards also impose inconvenience and expense. In digital cameras, the biggest problem is connecting the memory card to other equipment such as stereo equipment, video devices or PCs, so that a person can view and store videos, images, and sound. This problem is exacerbated by the various card formats released to date that are not compatible with each other. Consumers do not want to buy and deal with more than one reader, and they resent being told that the equipment they already own is obsolete. Without simple, convenient interconnection technology, sales of the next generation of clever appliances will never reach its potential.

Even when physical interconnectivity is addressed, there remains the problem of maintaining the security of the information transferred. For example, it is difficult to authenticate a subscriber to an Internet music service and ensure convenient listening for a valid user while preventing access by to unauthorized users. The optimal solution to these and related problems would be a method to combine authentication, storage, and connectivity functions in a convenient system that would not require the user to obtain and install new equipment. Moreover, for such a solution to be truly viable, it would work with existing, legacy equipment that the majority of users already have and know how to use.

These and other problems are addressed by the present invention as set forth in the remainder of this specification referring to the attached drawings.

### SUMMARY OF THE INVENTION

The present invention is directed to systems and methods for securely handling data and information that may be used by, or communicated in, information systems. This will include securely storing and accessing data on a medium of the present invention that has the appearance of a standard optical disc such as a CD, DVD, or Blu-Ray disc. The present invention permits the packaging and porting of inexpensive electronic circuits so that they will have the same form as optical discs and will mimic their operating characteristics. The present invention may be embodied in media that may take any shape that is compatible with optical disc technologies such as CDs and DVDs. These shapes may include, but are not limited to, a corporate ID card, credit card, camera card, or music card. They may also include hybrid cards, for example, a credit card with both a conventional magnetic stripe and an optical transceiver or a corporate ID card that has both a RFID apparatus and an optical transceiver. Further, the present invention may be used for the interconnection of electronic devices without the need of specialty cables or conventional wireless connections. Lastly, the present invention provides for authenticated access and secure storage of data or information downloaded from a source, such as music from an Internet site, to enhance control of replaying and copying of the downloaded data or information.

The disc that embodies the present invention is compatible for insertion in a CD or DVD drive of a standard laptop, desktop, PDA, or other portable electronic device. The disc of the present invention can generate data that is intelligent, dynamic and adaptive. The use of the CD or DVD format makes the present invention compatible for incorporation with current information systems.

With regard to the security aspect of the present invention, password access is replaced by multi-factor security protocols that are conventional. The security protocol includes at least two-factor authentication. The present invention may be embodied in a security card that is shaped like a standard company ID card. That is, it may be rectangular, about the size of a business card, and have, for example, a 15 mm hole at its center of mass that is sized to fit the spindle of a standard CD/DVD player. Therefore, this card may be placed in the CD/DVD player of any electronic device capable of receiving it. As such, there is not a need for a dedicated reader for reading the information ID card.

Because the ID card of the present invention may stay in the computer throughout most secure sessions, it can conveniently provide atomic transactions, i.e., sessions that encompass a series of steps which is executed completely or not at all. Also, while the card is in the CD drive, it can retrieve and store information, for example, from a computer for new access codes as new applications proliferate.

The present invention also provides “portable preferences” that simplify the administration of the use of the card. This enables one access method to work on more than one computer, which is very useful in accessing web-based systems.

The present invention provides a solution to the fundamental problem for CNP transactions. It overcomes the problem associated with the inability of merchants to verify the identity of the purchaser during the purchasing process, while simultaneously ensuring a convenient experience for customers. In this case, the embodiment of the present invention would be the size of a standard credit card. It would have a hole at its center so it would fit in standard CD/DVD players of computers. The credit card would provide two-factor authentication. This would be effected by placement of the credit card in the computer's CD/DVD player at the purchaser's location. The purchaser would then enter a PIN number or other supplemental factor, such as a fingerprint scan, iris scan, voice clip, or software token. Conventional associated validation software would assess the card and the supplemental factor or factors. This software may reside on the card, the user's computer, or the merchant's computer. If the two (or more) factors are validated by the software, then the purchaser would be cleared for online purchases. There would be no need to expense, install, or maintain credit card readers or any other readers. This type of verification is comparable with the verification that takes place in face-to-face transactions.

The present invention provides a system and method that improves the interconnectivity of electronic devices and reduces dependence on specialty cables and specific software for wireless connections. For example, if an individual has a digital camera, there are many cases in which downloading images from the camera to the user's computer requires the use of a specialty cable, memory card reader, or both. These cables also may require special terminal connectors at the computer to receive the cable, which the user may not have. The present invention would provide a digital filmcard that may be inserted in a digital camera. This filmcard has a hole in the center that fits the spindle of a standard CD/DVD player. The card would be used to take pictures. The card would store the images and then be removed from the camera and placed in the CD or DVD player in computers and video systems to view and store the images. The images are instantly available and no cables are required to transmit the images from the camera to the computer or video systems. Further, no new reader is needed to effect this image reproduction or storage on the computer or video system.

The present invention provides a disc that is configured to securely access, for example, music or other information from a source on the Internet based on at least two-factor authentication. Once the authentication is complete, the music may be played from the source through a process sometimes referred to as streaming. When desired, the music could also be downloaded from the source, and the source will internally program the disc for playback, playback and limited copying, or playback and unlimited copying. If only playback is authorized, the disc could then be placed in a stereo system or CD player for playback but copying could not be permitted. As such, the disc would act a secure data storage system.

These and other aspects of the present invention will be described in detail in remainder of the specifying, claims, and attached drawings.

### BRIEF DESCRIPTION OF THE DRAWINGS

FIG. 1 shows a perspective view of an embodiment of the present invention.

### DETAILED DESCRIPTION OF THE DRAWINGS

The present invention relates to systems and methods for securely handling data or information that may be used by, or communicated in, information systems. This will include, but not be limited to, securely storing and accessing data on a medium that looks like a standard as CD or DVD. More specifically, the present invention permits the packaging and porting of inexpensive electronic circuits so that they will have the same size and operating characteristics CDs and DVDs. It is within the scope of the present invention that the embodiments of the present invention may take any shape of a standard CD or DVD. Further, the present invention may be used for interconnecting electronic devices without the need for cables or conventional wireless connections. The present invention may also be used to provide a system and method to securely control access to and/or securely store data or information from a source, and to control the ability to copy downloaded data or information.

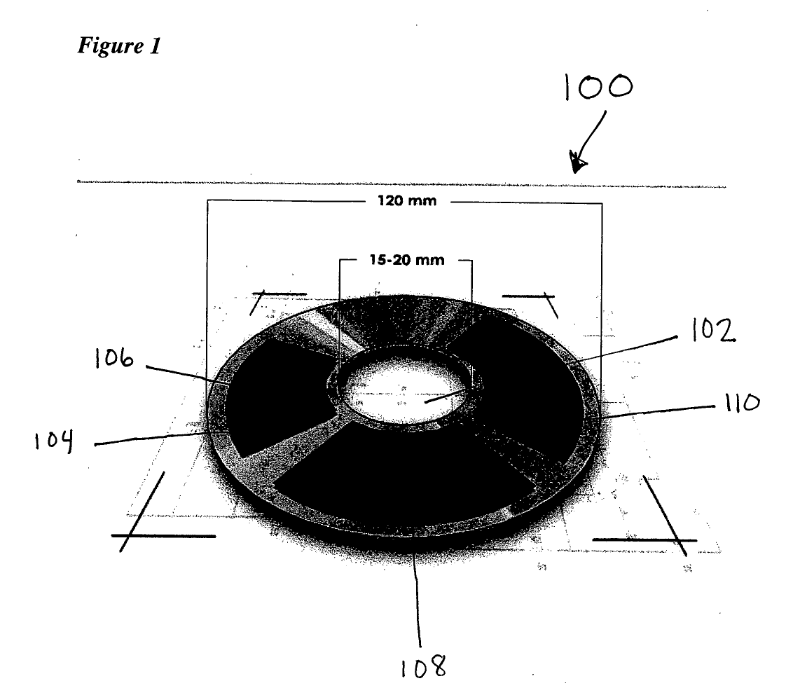

Referring to FIG. 1, a perspective view of an embodiment of the disc according to the present invention is shown at 100. Disc 100 has centered hole 102 that is sized to fit the spindle of a conventional CD/DVD player that may be internally or externally connected to a desktop or laptop computer. Disc 100 has a number of sections contained on it. These sections are accessed through the optical head of the CD/DVD player. The sections contained on disc 100 include optical window 104, power aperture 106, control logic 108, and memory 110. The optical window or windows 104 includes cells or disc regions in which optically active elements create or modulate light. The power aperature(s) 106 includes cells or disc regions in which photovoltaic components or energy harvesting components produce or convert energy for use by the disc. The control logic 108 provides intelligence and sensors to selectively activate optical window(s) 104, to render security calculations, and to interpret date. Memory 110 provides storage for augmentative and related information.

Disc 100 may have the look and size of a conventional CD, DVD, or optical disc, but that is where the similarity ends. The content of disc 100 includes conventionally represented data and augmentative data, which will be described in detail. The conventionally represented data takes the form of pits and lands physically encoded onto the optical disc substrate using stamping or other methods that are known. The augmentative data takes the form of optical window 104 or a plurality of such windows. These windows may be configured to generate light or occlude the transmission and reflection of light from the read laser in the optical drive. The augmentative data is controlled by intelligent circuitry onboard the disc and will be described in detail subsequently.

The CD, DVD, or optical disc reader interprets the combination of conventionally represented and augmentative data as the output from a standard disc. This method employs conventional stamping and related processes to store static data. Electronic elements are used to add intelligence, dynamic memory, and security to the data that is conventionally stored.

In operation, conventional associated validation software may be used to check for the presence of the augmentative data to determine whether a disc is a valid original or an illegitimate copy. For example, the software could direct the drive to read a certain track, sector, or other portion of the disc, wait for a latency period, and then re-read the same track of the disc. In concert, the intelligence on the disc could activate the augmentative data stream to dynamically alter the file allocation table on the disc so that it would read a different track as if it were the originally designated track. If this is performed, two different data streams would result from this read/re-read operation. The software would interpret this change as indicative of an original and thus valid disc. In contrast, if the read/re-read operation produced two identical copies of one of the tracks, then the software would deduce the disc is a copy. Attempts to copy the disc through most practical means would produce a static copy incapable of the dynamic read/re-read pairs required for validation. This process can be repeated to avail a set of read/re-read pairs.

Similarly, the onboard intelligence could activate the augmentative data to render certain tracks unreadable. For example, by rendering the file allocation table unreadable, the disc would not operate properly. The augmentative data would be de-activated, and, thus, the disc would become readable, only when acceptable validation factors are present. These factors may include, but are not limited to, the pressing of low-profile buttons on the disc in a certain order, the passage or non-passage of a certain amount of time, or a patterned succession of read attempts. The latter may evince an augmentative-data deactivation signature from coded movements of the drive head.

When the disc is effected as a security token, the non-readability of the disc followed by readability may contribute to the validity assessment of the token. It is fully contemplated that the present invention will permit the whole-disc construct to be combined with the partial-disc dynamic readability of tracks or other disc portions and the advantages of the present invention will be realized.

To implement the use of the mixture of conventionally stored static data and augmentative dynamic data, the present invention employs light-generating and light-occlusive modes. Each mode may be implemented in macro and micro submodes. These modes and submodes are implemented according to the following description.

In the light-generating mode, the optical window, such as window 104 in FIG. 1, generates light. In operation, this light may be produced by a light-emitting diode (LED) or similar component. Such LEDs are available in dimensions comparable to those required by the form factor of optical discs. In the macro submode, the LED or similar source is collocated with the disc substrate so that the light generated floods an area of the disc that is large relative to the dimensions of the pits and lands on the disc. On a CD, these dimensions are approximately 0.6 microns wide (orthogonal to the track's read direction) by approximately 1.5 microns long (running along the track's read direction). These dimensions are provided only as one possible set of dimensions and are not meant to limit the present invention.

The light source may be oriented so that many total-internal and nearly total-internal reflections of the light take place within the disc substrate. In such a situation, when the source is activated, this mode and submode effectively overwhelm the pit/land reflectance transitions on which the optical drive relies to read conventionally stored data from the discs. This will render the affected portion of the disc unreadable.

In the light-generating mode's micro submode, the LED or similar source is precisely located through photolithography or other precise means, to present light to an area that approximately correlates at a minimum with a single track, frame, sector, or pit/land transition on the disc. As with the macro submode, the result of this presentation is that the drive will receive light from the source and interpret the light as if it were reflected from a pit/land transition. Consequently, the data stream the drive receives will be different with and without activation of the light-generating source or sources. This difference may be used for validation of the disc for security purposes, or the difference may invoke two forms of usable data. For example, a single disc may include two selectable formats of the same data, such as regular- and high-definition versions of a video or music signal.

In the light-occlusive mode, a component that switchably blocks or transmits light is used instead of a component, such as small LED, that switchably generates light. This component may be a liquid crystal cell, an electrochromic laminate, a microfluidic region influenced electrically or by disc rotation, or a similar construct that permits light from the read laser on the optical drive to pass to not to pass. It is understood that other methods may be used for the occlusion of light and still be within the scope of the present invention.

In the light-occlusive mode's macro submode, a region that is large relative to the dimensions of the pits and lands is activated or de-activated. In the micro submode, an area that is comparable in size and precision of location to at a minimum a specific track, frame, sector, or pit/land transition is activated or de-activated. This will perform the light occlusive function for the disc of the present invention.

It is understood that both modes and submodes may be combined on a single disc.

In operation, the decision to employ macro or micro submode may be based on the manufacturing cost of precisely collocating the active elements and on the power requirements of the active elements. When used in macro submode, light-generating active elements such as LEDs, consume approximately 2 to 60 mw to produce approximately 2 to 38 millicandelas from a 1.0 mm by 0.5 mm footprint in a profile of 0.45 mm. The profile of a standard CD is approximately 1.0 to 1.4 mm. The onboard circuitry will require power, as well as the active elements. For example, a high-end integrated circuit capable of generating a 1,024-bit RSA signature in 15 ms draws approximately 0.3 mw of power per megahertz of clock frequency. To perform the activity within 15 ms, the circuit would have to operate at 200 MHz. This operation would draw 60 mw of power.

In write mode, flash memory circuits will consume approximately equal amounts of power. In read mode, they will consume about 2 orders of magnitude less power.

Light-occlusive active elements, such as liquid crystal cells, draw on the order of 5 microwatts of power per 25 square mm occluded. This figure varies with the opacity and reaction time of the crystal.

To generate power to drive the active elements plus the intelligence, storage, security, and related circuits, the disc uses energy harvesting. The energy harvesting may be performed using power aperture 106. A photovoltaic cell at this location harvests energy from the read laser of the optical drive. This cell may be replaced by similar harvesting components, including MEMS microgenerators, a coil positioned to induce a current from stray magnetic fields in the drive, a piezoelectric element cantilevered to vibrate consequent to the acceleration of the disc, or a heat-electricity converter such as a harvesting thermocouple, and still be within the scope of the present invention.

To enhance energy harvesting, the present invention may use techniques that will be described. A battery or low-leakage capacitor may store harvested energy. An external magnet may be supplied with the disc, typically in the form of an adhesive sticker with suitable trade dress. This magnet would be attached to the drive well wall in an orientation that presents magnetic flux lines to the coil associated with the disc, thus enhancing the stray magnetic fields in the drive. There is also considerable rotational energy available for conversion. The drive spins discs at rates of 200 to 500 RPM in 1× mode, faster in 2× and higher modes.

The intelligence onboard the disc may include sensors that detect light, spin rate, or acceleration to determine the rotational position of the disc relative to the drive head. This detection enables the active elements to be activated only when they pass over the drive head, thus conserving energy. The spindle hole, which is conventionally located at the center of mass of the disc, may be located off center by a distance that produces slight vibrations to power energy harvesting components while still within the balance requirements of the optical disc standard for which the disc is produced. Alternatively, a component may displace a mass slightly to effectively relocate the center of mass as needed to contribute to energy harvesting. The displaced mass may be a solid, a microfluid, or a colloid, and it may be controlled electronically, magnetically, or rotationally. In particular, a magnetically influencible fluid may move due to centrifugal force as the disc starts to spin. During the initial movement, the disc will vibrate slightly to generate power. After the movement, the disc will be balanced and will vibrate much less or not at all. When the disc stops spinning after use, a magnetic field, an electric field, or the viscoeleasticity of the fluid returns the fluid to its starting position.

The onboard intelligence may also include means to activate augmentative data elements on the disc in order to change the spin rate of the disc episodically. The consequent positive and negative acceleration of the disc would contribute energy to the system by varying the relative position of a flexibly positioned piezo-electric component and the disc itself.

For specialized purposes, the present invention may be implemented such that all or nearly all of the data on the disc is stored using the augmentative methods describe above, with none or nearly none of the data conventionally stored. This could include dynamic data storage for information appliances. In this and related applications, static pits and lands could be positioned adjacent each track of augmentative elements. These static-side tracks could provide tracking information to the drive head. Likewise, static codes within and alongside the main track could provide focusing information to the head. This tracking and focusing information could include codes for influencing the drives interpretation of the ellipsoidal-reflection detection circuitry common to many optical drives.

The data storage and data security functions described above may be combined on one disc.

It is understood that the IEC/ISO 10149 optical disc standard, related standards, and the industry's formal and informal operating conventions allow the form factor of optical discs to vary. While the circular shape and 120 mm. diameter of most audio CDs may be the form factor most frequently observed, other form factors such as “business card” sized CDs are also within the scope of the present invention. Fully functional and compliant discs have even been produced in forms that emulate a company's logotype, the symbol for a musical group, or other art. The present invention may be produced according to the standards required by a desired optical disc/disc reader pair in convenient form factors. In particular, the present invention may present the form factor of a conventional audio disc, a single track audio short play disc, a company ID card, a credit card, or a memory storage/transport card. The shape of the disc may be circular, elliptical, rectangular, or rectangular with rounded ends or corners, and will still be within the scope of the present invention.

A two or more factor authentication security protocol may be implemented by disc 100. One factor, may be conventional such as something the user possesses, which could be the disc or card itself. Another factor may be a PIN. Conventional associated validation software on the user's computer or elsewhere in a distributed system asks for and assesses the validity of the two factors. A fingerprint scanner may be incorporated into the disc as a third factor or as a replacement for the PIN. Such scanners are available in profiles comparable to the profile of optical discs. Likewise, a series of buttons on the disc could enable the user to enter a PIN onto the card itself, along with other operating data. Moreover, the method of using the optical window for determining if the disc is an original disc may be used in the authentication process.

If the entered PIN is incorrect, an alert may be transmitted, or only limited access will be provided to the user, if any access is provided at all. If the correct PIN is input, it will open specific portions of the card for communication with the computer. If the card is the correct card for that computer and computer user, the communication between the card and computer will result in the second level authentication being passed, thereby granting the computer user access to the computer or also access to secure areas of the computer. If the second level of authentication is failed, the user will not have access to the computer or to non-secure areas of the computer depending on the internal programming of the computer.

The information that is exchanged between the disc or card and the computer or information appliance may include cryptographic keys for authenticating users, as well as for encrypting and decrypting data. This approach, while simple, presents security vulnerabilities. To manage them, the exchange may also include message digests and mathematical hashes of keys. In this way, certain especially secret keys, such as the private key in a public-private key system, may reside on the disc and never be required to be transmitted from the disc. Rather, an inquiry is made to the intelligent integrated security circuit on the disc, and the disc replies that the inquiry matched or did not match the private key. In this manner, the private key is not revealed. To do this, the associated validation software for the disc may direct a pattern of read requests to the disc, or move the head of the optical drive, or adjust the speed of the drive, or illuminate the drive's read and write lasers or similar sources to communicate the inquiry through photovoltaic and motion sensors on the disc. Similarly, certain conventional key generation algorithms enable a symmetric key to be agreed upon between two parties communicating in the clear, i.e., when vulnerable to eavesdropping. For example, the well-established Diffie-Hellman key exchange algorithm enables two parties to communicate openly and agree on a secret key. This algorithm requires that a message be shared in common between the two parties The message is one of the numbers both will use in the algorithm. This number may also be communicated to the disc through control of the drive laser, head, or spindle via associated validation software as described above.

The validation software relies on conventional algorithms. The software may be conveniently distributed on the disc itself. This is beneficial for the user. It avoids downloads and the viruses and firewall issues that complicate the download process.

If the security protocol is set such that the card does not have to be left in the CD/DVD drive for the entire secure session, it may be removed after the second level of authentication is passed. At the time of removal, the card will have been dynamically changed by the information exchange between the card and computer, and the card and computer will note their respective states. When the secure session is completed and ended, it cannot be entered again until the two levels of authentication are passed. As to the second level of authentication under these circumstances, the card will look to match the state on the computer when the card was removed based on the dynamic information exchange. If the dynamic information exchange is successful, then the user will pass the second level of authentication rendering the computer usable as previously described.

The present invention provides a solution for the fundamental problems associated with CNP transactions. It provides online merchants with the ability to verify the identity of the purchaser during online purchasing, while simultaneously ensuring a convenient experience for purchasers. This type of authentication is comparable to the authentication that takes place in face-to-face transactions.

In practice, the potential purchaser would identify a product or service to be purchased online with a participating merchant. At this time, the potential purchaser would place his/her card in the computer's CD/DVD player at the purchaser's location. The purchaser would then enter his/her PIN number when prompted. If the PIN is verified by the validating software, the card will then communicate with the merchant location via, for example, the Internet connection. The information exchange between the credit card and merchant location would involve the dynamic exchange of information and if this information comports with what the merchant system requires for second level authentication, then this second level will be passed. If the two levels of authentication are passed, the purchaser would be cleared for online purchases with that merchant. The passing of the two levels of authentication provides a level of confidence for the merchant that a CNP purchase is not fraudulent.

The present invention also provides a system and method to overcoming many of the problems associated with the requirement to have specialty cables for the interconnection of electronic devices. For example, if an individual has a digital camera, there are many cases in which in order to download the pictures to the user's computer, it requires the use of a specialty cable. These cables also may require special terminal connectors at the computer, requiring the computer user to purchase a special adapter to download the images to the computer.

Again taking a digital camera as an example, the present invention may be configured as a filmcard that would fit into a digital camera. The filmcard is sized and configured so that when it is inserted in the digital camera, it exposes the portion of the card appropriately in the camera for storing the images on the card.

In operation, the filmcard would be inserted in the digital camera. Once the pictures are taken and the images are stored on the filmcard, the filmcard may be removed from the camera and placed in the CD or DVD player in computers and video systems to view and store the images. The images are instantly available and no cables are required to transfer the images from the camera to the computer or video systems. Further, no new reader is needed to effect this image reproduction.

The present invention also provides a CD/DVD style disc that may be configured to securely download, for example, music or other information from a source on the Internet based on at least two-factor authentication, and control the playback and copying of the downloaded data or information. A disc for this purpose could be a disc such as disc 100 shown in FIG. 1.

The two-factor authentication may be a PIN entered for accessing the disc, and then a dynamic information exchange between the disc and a music download site. Once the authentication is completed, the desired music may be downloaded. This download activity maybe automatically connected to the customer's credit account, which will be charged for the download. As the download takes place, the disc may be internally programmed from music download site for various functions, which may include playback only, playback and limited copying, or playback and unlimited copying. It also may be programmed to allow access to the downloaded data or information for a predetermined period of time. If the programming is for playback only, the disc could then be played in a stereo system or portable CD player but not copied. In this case, the disc would act a secure data storage system.

Further, the disc may be internally programmed, as stated, for a predetermined useful life of the stored media. As such, after a predetermined period of time has expired, the downloaded stored media would no longer be accessible. Additionally, the disc could be internally programmed to automatically renew the use of the downloaded media by charging the credit account of the customer for desired renewal periods. This will continue until the customer indicates a desire to longer to view the media. At the time, the media will no longer be accessible.

Although the storage of data has been described in light of the storage of music, it applies equally to other media such a film and still be with the scope of the present invention

The terms and expressions that are employed herein are terms or descriptions and not of limitation. There is no intention in the use of such terms and expressions of excluding the equivalents of the feature shown or described, or portions thereof, it being recognized that various modifications are possible within the scope of the invention as claimed.

1. A configurable substrate capable of insertion in an electronic device for securely controlling access to and handling of at least data electronically stored on an electronic storage medium, comprising:
the substrate having a size and shape that permits of insertion in a reader of the electronic device, with the reader being capable of retrieving data from and writing data to the substrate, with the substrate further having at least,
a memory region for storing data that is readable by the reader, with the data in the memory region being controllably accessible;
optical window region for controlling the operability or inoperability of the substrate within the electronic device;
control logic region for controlling access to the data in the memory region and controlling the optical window region for the operability and inoperability of the substrate electronic device; and
power aperture region for providing power to substrate for powering functionality of the substrate to render it operable or inoperable within the electronic device.

2. The configurable substrate as recited in claim 1, wherein the substrate includes the size and shape of a compact disc (CD) or digital versatile disc (DVD).

3. The configurable substrate as recited in claim 1, wherein at least the data in the memory is encoded by pits and lands.

4. The configurable substrate as recited in claim 1, wherein the optical window includes augmentation data for controlling the operability or inoperability of the substrate within the electronic device.

5. The configurable substrate as recited in claim 4, wherein the augmentation data is capable of generating light for controlling the operability within the electronic device.

6. The configurable substrate as recited in claim 4, wherein the augmentation data is capable of occluding transmission and reflection of light for controlling the operability of the substrate within the electronic device.

7. A method for controlling access to and handling of at least data electronically stored on an electronic storage medium, comprising the steps of:
(a) inserting a substrate in the electronic device with the substrate having at least an optical window region containing augmentation data for controlling the operability or inoperability of the substrate within the electronic device, control logic region for controlling the augmentation data, and a memory region for storing data readable by a reader of the electronic device;
(b) reading the substrate with the reader of the electronic device to determine if augmentation data is present on the substrate;
(c) reading a predetermined first portion of the memory region at time T₁;
(d) activating the augmentation data using the control logic region and the reader to dynamically change at least a part of the portion of the memory region that was read at time T₁ so that an attempt to read the first portion read at step (c) will result in reading a second portion of the memory region;
(e) at time T₂, which is after time T₁, attempting to read the first portion of the memory region read at step (c) at a same location allocation of the memory region and reading a second portion of the memory location;
(f) determining that the substrate is an original substrate if at step (e) a second portion of the memory region is read at a same location allocation for the first portion of the memory region; and
(g) permitting access to the electronic device if the substrate at step (e) is determined to be an original substrate.

8. The method as recited in claim 7, wherein the method includes using a second authentication factor for permitting access to the electronic device.

9. The method as recited in claim 7, wherein the second method of authentication includes entering a personal identification number (PIN) for providing access to the electronic device to at a minimum permit the processing of the substrate in the electronic device.

10. The method as recited in claim 8, wherein the method include using more than two authentication factors for permitting access to the electronic device.

11. A method for controlling access to and handling of at least data electronically stored on an electronic storage medium, comprising the steps of:
(a) inserting a substrate in the electronic with the substrate having at least an optical window region containing augmentation data for controlling the operability or inoperability of the substrate within the electronic device, control logic region for controlling the augmentation data, and a memory region for storing data readable by a reader of the electronic device;
(b) reading the substrate with the reader of the electronic device to determine if augmentation data is present on the substrate;
(c) reading a predetermined first portion of the memory region at time T₁;
(d) activating the augmentation data using the control logic region and the reader to dynamically change at least a part of the portion of the memory region that was read at time T₁ so that an attempt to read the first portion read at step (c) will result in reading a second portion of the memory region;
(e) at time T₂, which is after time T₁, attempting to read the first portion of the memory region read at step (c) at a same location allocation of the memory region and reading a second portion of the memory location;
(f) determining that the substrate is an original substrate if at step (e) a second portion of the memory region is read at a same location allocation for the first portion of the memory region and proceeding to step (f) and if not proceeding to step (g) and (h);
(g) permitting access to the electronic device if the substrate at step (e) is determined to be an original substrate;
(h) generating light with the substrate to render at least part of the substrate inoperable sufficient to prevent access to the electronic device.

12. The method as recited in claim 11, wherein the method includes using a second authentication factor for permitting access to the electronic device.

13. The method as recited in claim 11, wherein the second method of authentication includes entering a personal identification number (PIN) for providing access to the electronic device to at a minimum permit the processing of the substrate in the electronic device.

14. The method as recited in claim 12, wherein the method include using more than two authentication factors for permitting access to the electronic device.

15. A method for controlling access to and handling of at least data electronically stored on an electronic storage medium, comprising the steps of:
(a) inserting a substrate in the electronic with the substrate having at least an optical window region containing augmentation data for controlling the operability or inoperability of the substrate within the electronic device, control logic region for controlling the augmentation data, and a memory region for storing data readable by a reader of the electronic device;
(b) reading the substrate with the reader of the electronic device to determine if augmentation data is present on the substrate;
(c) reading a predetermined first portion of the memory region at time T₁;
(d) activating the augmentation data using the control logic region and the reader to dynamically change at least a part of the portion of the memory region that was read at time T₁ so that an attempt to read the first portion read at step (c) will result in reading a second portion of the memory region;
(e) at time T₂, which is after time T₁, attempting to read the first portion of the memory region read at step (c) at a same location allocation of the memory region and reading a second portion of the memory location;
(f) determining that the substrate is an original substrate if at step (e) a second portion of the memory region is read at a same location allocation for the first portion of the memory region and proceeding to step (f) and if not proceeding to step (g) and (h);
(g) permitting access to the electronic device if the substrate at step (r) is determined to be an original substrate;
(h) occluding transmission and reflection of light at the substrate to render at least part of the substrate inoperable sufficient to prevent access to the electronic device.

16. The method as recited in claim 15, wherein the method includes using a second authentication factor for permitting access to the electronic device.

17. The method as recited in claim 15, wherein the second method of authentication includes entering a personal identification number (PIN) for providing access to the electronic device to at a minimum permit the processing of the substrate in the electronic device.

18. The method as recited in claim 16, wherein the method include using more than two authentication factors for permitting access to the electronic device.
